(19) United States
(12) Patent Application Publication
(10) Pub. No.: US 2022/0356928 A1
(43) Pub. Date: Nov. 10, 2022

(54) Transmission for a Motor Vehicle

(71) Applicant: ZF Friedrichshafen AG, Friedrichshafen (DE)

(72) Inventors: Stefan Beck, Eriskirch (DE); Matthias Horn, Tettnang (DE); Thomas Kroh, Lindau (DE); Thomas Martin, Weissensberg (DE); Johannes Kaltenbach, Friedrichshafen (DE); Michael Wechs, Weißensberg (DE); Fabian Kutter, Kressbronn (DE); Max Bachmann, Friedrichshafen (DE); Peter Ziemer, Tettnang (DE); Martin Brehmer, Tettnang (DE); Juri Pawlakowitsch, Kressbronn (DE); Oliver Bayer, Hörbranz (AT)

(21) Appl. No.: 17/618,688

(22) PCT Filed: Mar. 5, 2020
(86) PCT No.: PCT/EP2020/055778

§ 371 Date: Dec. 13, 2021

(30) Foreign Application Priority Data
Jun. 11, 2019 (DE) 10 2019 208 481.8

(51) Int. Cl. F16H 3/56

(52) U.S. Cl. CPC F16H 3/56; F16H 2200/0021; F16H 2200/0039; F16H 2200/2007; F16H 2200/2041

(57) ABSTRACT

A transmission (G) for a motor vehicle includes an electric machine (EM), a first input shaft (GW1), a second input shaft (GW2), an output shaft (GWA), a planetary gear set (P1), a pre-ratio configured as a spur gear transmission (SRS), and at least four shift elements (A, B, C′, D). Different gears are selectable by selectively actuating the at least four shift elements (A, B, C′, D) and, in addition, in interaction with the electric machine (EM), different operating modes are implementable.

### CROSS-REFERENCE TO RELATED APPLICATIONS

The present application is related and has right of priority to German Patent Application No. 102019208481.8 filed in the German Patent Office on Jun. 11, 2019 and is a nationalization of PCT/EP2020/055778 filed in the European Patent Office on Mar. 5, 2020, both of which are incorporated by reference in their entirety for all purposes.

### FIELD OF THE INVENTION

The invention relates generally to a transmission for a motor vehicle, including an electric machine, a first input shaft, a second input shaft, an output shaft, and a first planetary gear set having multiple elements, wherein a first, a second, a third, and a fourth shift element are provided, and a pre-ratio configured as a spur gear transmission having multiple spur gears. Moreover, the invention relates generally to a motor vehicle drive train, in which an aforementioned transmission is utilized, and to a method for operating a transmission.

### BACKGROUND

In the case of hybrid vehicles, transmissions are known which also include, in addition to a gear set, one or multiple electric machine(s). In this case, the transmission is usually configured to be multi-stage, i.e., multiple different transmission ratios are selectable, as gears, between an input shaft and an output shaft by actuating appropriate shift elements, wherein this is preferably automatically carried out. Depending on the arrangement of the shift elements, the shift elements are clutches or also brakes. The transmission is utilized in this case for suitably implementing an available tractive force of a prime mover of the motor vehicle with respect to various criteria. In this case, the gears of the transmission are mostly also utilized in interaction with the at least one electric machine for implementing driving under purely electric motor power. Frequently, the at least one electric machine can also be integrated in the transmission in order to implement various operating modes in different ways.

FIG. 1 from DE10 2012 212 257 A1 describes a transmission for a hybrid vehicle, which includes, in addition to a first input shaft and an output shaft, three planetary gear sets and an electric machine. Moreover, in the variant, four shift elements are provided, via which different power paths are achieved from the first input shaft to the output shaft while implementing different gears and, in addition, different integrations of the electric machine can be configured. Here, driving under purely electric motor power can also be implemented simply by transmitting power via the electric machine. In the smaller of the two electric gears, a re-starting of the internal combustion engine is possible only with an interruption of tractive force, since the transmission input shaft is braked in the first electric gear.

### SUMMARY OF THE INVENTION

Example aspects of the present invention provide an alternative embodiment of the transmission for a motor vehicle known from the prior art, with which, in combination with a compact design, different operating modes can be implemented in a suitable way.

According to example aspects of the invention, a transmission includes an electric machine, a first input shaft, a second input shaft, an output shaft, as well as a first planetary gear set and a second planetary gear set. The planetary gear sets include multiple elements, wherein, preferably, a first element, a second element, and a third element are associated with each of the planetary gear sets. In addition, a first shift element, a second shift element, a third shift element, and a fourth shift element are provided, via the selective actuation of which different power paths can be implemented while shifting different gears. It is particularly preferred when at least three gears can be formed between the first input shaft and the output shaft, which differ with respect to the transmission ratio. Moreover, a rotor of the electric machine is connected to the second input shaft.

Within the meaning of the invention, a “shaft” is understood to be a rotatable component of the transmission, via which associated components of the transmission are rotationally fixed to each other or via which a connection of this type is established upon actuation of an appropriate shift element. The particular shaft can connect the components to each other axially or radially or also both axially and radially. The particular shaft can also be present as an intermediate piece, via which a particular component is connected, for example, radially.

Within the meaning of the invention, “axially” means an orientation in the direction of a longitudinal central axis, along which the planetary gear sets are arranged coaxially to one another. “Radially” is then understood to mean an orientation in the direction of the diameter of a shaft that lies on this longitudinal central axis.

Preferably, the output shaft of the transmission includes a tooth system, via which the output shaft is then operatively connected, in the motor vehicle drive train, to a differential gear arranged axially parallel to the output shaft. In this case, the tooth system is preferably provided at a mounting interface of the output shaft, wherein this mounting interface of the output shaft is preferably situated axially in the area of an end of the transmission, at which a mounting interface of the first input shaft is also provided, the mounting interface establishing the connection to the upstream prime mover. This type of arrangement is particularly suitable for the application in a motor vehicle with a drive train aligned transversely to the direction of travel of the motor vehicle.

Alternatively, an output of the transmission can also be provided, in principle, at an axial end of the transmission situated opposite to a mounting interface of the first input shaft. In this case, a mounting interface of the output shaft is then designed at an axial end of the output shaft coaxially to a mounting interface of the first input shaft, so that the input and the output of the transmission are located at opposite axial ends of the transmission. A transmission configured in this way is suitable for the application in a motor vehicle with a drive train aligned in the direction of travel of the motor vehicle.

The planetary gear sets are preferably arranged in the sequence first planetary gear set and second planetary gear set axially following the mounting interface of the first input shaft. Within example aspects of the invention, an alternative arrangement of the planetary gear sets can also be implemented in the axial direction, provided the connection of the elements of the planetary gear sets allows this.

Example aspects of the invention now include the technical teaching that

a first element of the first planetary gear set is fixable at a rotationally fixed component by the first shift element;

the first input shaft is rotationally fixable to the first element of the first planetary gear set by the second shift element;

the first planetary gear set is interlockable by connecting two of the three elements of the first planetary gear set in a rotationally fixed manner by the fourth shift element;

the second element of the first planetary gear set is rotationally fixed to the output shaft;

the rotor of the electric machine is connected to the second input shaft via the pre-ratio configured as the spur gear transmission;

the second input shaft is rotationally fixed to an element of the first planetary gear set; and

the third shift element is designed to rotationally fix the first input shaft to the second input shaft.

If a planetary gear set is interlocked, the ratio is always one regardless of the number of teeth. In other words, the planetary gear set revolves as a block.

The interlock can take place in such a way that the fourth shift element
connects the first element to the second element of the first planetary gear set,
connects the first element to the third element of the first planetary gear set, or
connects the second element to the third element of the first planetary gear set.

The first, second, third, and fourth shift elements are preferably present as clutches, which, upon actuation, each synchronize, if necessary, the particular components of the transmission joined directly to the clutches, with respect to their turning motions and, thereafter, connect the components to each other in a rotationally fixed manner.

A particular rotationally fixed connection of the rotatable components of the transmission is preferably implemented, according to example aspects of the invention, via one or also multiple intermediate shaft(s), which can also be present, in this case, as short intermediate pieces when the components are positioned in a spatially dense manner. Specifically, the components that are permanently rotationally fixed to each other can each be present either as individual components that are rotationally fixed to each other, or also as single pieces. In the second variant mentioned above, the particular components and the optionally present shaft are then formed by one shared component, wherein this is implemented, in particular, when the particular components are situated spatially close to one another in the transmission.

In the case of components of the transmission that are rotationally fixed to each other only upon actuation of a particular shift element, a connection is also preferably implemented via one or also multiple intermediate shaft(s).

A fixation takes place, in particular, by way of a rotationally fixed connection to a rotationally fixed component of the transmission, which is preferably a permanently non-rotating component, preferably a housing of the transmission, a part of such a housing, or a component rotationally fixed thereto.

Spur gears are intended to mean gearwheels. Preferably, the spur gear stage includes three spur gears, wherein a first spur gear is meshed with a second spur gear and the second spur gear is meshed with a third spur gear. The first spur gear can be rotationally fixed, in particular, to an element of the first planetary gear set, wherein this is preferably the third element of the first planetary gear set. The third spur gear can be, in particular, rotationally fixed to an input shaft of the electric machine, which can be connected to the rotor.

Within the meaning of the invention, the “connection” of the rotor of the electric machine to the input shaft is to be understood as a connection of such a type that a constant rotational-speed dependence prevails between the rotor of the electric machine and the second input shaft.

Overall, a transmission according to example aspects of the invention is distinguished by a compact design, low component loads, good gearing efficiency, and low losses.

According to one example embodiment of the invention, selective engagement of the four shift elements results in three gears between the first input shaft and the output shaft, which differ with respect to the transmission ratio.

In this way, a first gear can be implemented between the first input shaft and the output shaft by actuating the first shift element and the third shift element. In the process, driving is also implemented in each case with the simultaneous integration of the upstream prime mover and the electric machine.

A second gear can be implemented between the first input shaft and the output shaft by actuating the third and the fourth shift elements. In the process, driving is also implemented in each case with the simultaneous integration of the upstream prime mover and the electric machine.

A third gear can be implemented between the first input shaft and the output shaft in a first example variant by actuating the second and the fourth shift elements.

A third gear can be implemented between the first input shaft and the output shaft in a second example variant by actuating the second and the fourth shift elements. In the process, driving is also implemented in each case with the simultaneous integration of the upstream prime mover and the electric machine.

In the first gear and the first example variant of the third gear, a hybrid traveling mode or operation is present. The second example variant of the third gear is a purely internal-combustion-engine gear, in which the electric machine is decoupled.

Given a suitable selection of stationary transmission ratios of the planetary gear sets, a transmission ratio range which is suitable for the application in a motor vehicle is implemented as a result. In this case, gear shifts between the gears can be implemented, in which only the condition of two shift elements, in each case, is always to be varied, in that one of the shift elements contributing to the preceding gear is to be disengaged and another shift element is to be engaged in order to implement the subsequent gear. As a further consequence thereof, a shift between the gears can take place very rapidly.

Due to the connection of the electric machine to the second input shaft of the transmission, different operating modes can also be achieved in a simple way.

A first gear between the second input shaft and the output shaft can be utilized for driving under purely electric motor power, wherein this first gear results by engaging the first shift element. If the first shift element is actuated, the second input shaft and the output shaft are coupled to each other via the two planetary gear sets, and so driving can take place via the upstream electric machine. The torque of the input shaft is supported via the fixed third element of the second planetary gear set as well as via the fixed first element of the first planetary gear set.

In addition, a second gear can also be implemented between the second input shaft and the output shaft for driving under purely electric motor power. The fourth shift element is to be actuated in order to engage this second gear. If the fourth shift element is actuated, the second input shaft and the output shaft are coupled to each other via the two planetary gear sets, and so driving can take place via the upstream electric machine. In contrast to the purely electric first gear, the first planetary gear set is interlocked in the purely electric second gear.

During driving under purely electric motor power, the internal combustion engine can be decoupled, since the second shift element and the third shift element can remain in the non-actuated, i.e., disengaged, condition.

Starting from the purely electric second gear, in which only the fourth shift element is engaged, a direct transition into the two example variants of the third gears can take place. For the first example variant, the third shift element is to be engaged. For the second example variant, the second shift element is to be engaged.

This property also ensures that a gear shift can be carried out, with tractive force support, between the first example variant and the second example variant.

In addition, an electrodynamic starting operation (EDA) can be implemented. Electrodynamic starting means that a speed superimposition of the rotational speed of the internal combustion engine, the rotational speed of the electric machine, and the rotational speed of the output shaft takes place via one or multiple planetary gear set(s), and so it is possible to pull away from rest while the internal combustion engine is running. The electric machine supports a torque in this case.

The EDA mode is implemented simply by actuating the second shift element. In this mode, the first input shaft transmits torque onto the first element of the first planetary gear set while the electric machine is coupled to the third element of the first planetary gear set by the second planetary gear set. The first planetary gear set operates practically as a superposition gearbox.

In this way, a driving start forward is possible via the second element, which is connected to the output shaft. In this way, it is possible to start up and to drive also when the energy accumulator is dead.

Starting from the EDA mode, a direct transition into the second example variant of the third gear is possible. For this purpose, all that is necessary is to actuate the fourth shift element.

Moreover, a charging or starting function can be implemented by engaging the third shift element C. This is the case because, in the engaged condition of the third shift element, the second input shaft is directly coupled, in a rotationally fixed manner, to the first input shaft and, thereby, also to the internal combustion engine, wherein, simultaneously, an engagement with the output shaft GWA for power transmission does not exist (the first element of the first planetary gear set can rotate freely without load).

When the electric machine is operated as a generator, an electric accumulator can be charged via the internal combustion engine, whereas, when the electric machine is operated as an electric motor, a start of the internal combustion engine is implementable via the electric machine. Starting from this operation, a direct transition into the first gear or into the first example variant of the third gear can take place, in that the first shift element or the fourth shift element, respectively, is actuated.

In a preferred main driving operation, the transmission is provided, in particular, for driving under purely electric motor power with the internal combustion engine decoupled. In this case, the internal combustion engine is suited, in particular, as a type of range extender. When an additional electric machine is arranged at the other axle of the vehicle and is combined with the transmission, a serial operation is also possible. An additional electric machine of this type can support the tractive force during the transitions of the gears, and so a high degree of comfort is provided for the driver. The transmission can therefore be combined with an electric rear axle, for example, as a front-mounted transverse transmission.

In one example refinement of the invention, one or multiple shift element(s) is/are each implemented as a form-locking shift element. In this case, the particular shift element is preferably designed either as a constant-mesh shift element or as a lock-synchronizer mechanism. A synchronization of the shift elements can preferably take place via a closed-loop control of the rotational speed at the electric machine. A synchronization can also take place via a closed-loop control of the rotational speed of the internal combustion engine. Form-locking shift elements have the advantage over friction-locking shift elements that lower drag losses occur in the disengaged condition, and therefore a better efficiency of the transmission can be achieved. In particular, in the transmission according to example aspects of the invention, all shift elements are implemented as form-locking shift elements, and therefore the lowest possible drag losses can be achieved. In principle, however, one shift element or multiple shift elements could also be configured as force-locking shift elements, for example, as lamellar shift elements.

The planetary gear sets are preferably present as negative or minus planetary gear sets, wherein the first element of the particular planetary gear set is a sun gear, the second element of the particular planetary gear set is a planet carrier, and the third element of the particular planetary gear set is a ring gear. A minus planetary gear set is composed, in a way known, in principle, to a person skilled in the art, of the elements sun gear, planet carrier, and ring gear, wherein the planet carrier guides, in a rotatably mounted manner, at least one planet gear, although preferably multiple planet gears, each of which individually meshes with the sun gear and with the surrounding ring gear.

According to one further example embodiment of the invention, the first shift element and the fourth shift element are combined to form a shift element pair, with which one actuating element is associated. The first shift element, on the one hand, and the fourth shift element, on the other hand, can be actuated from a neutral position via the actuating element. This has the advantage that, due to this combination, the number of actuating elements can be reduced and, thereby, the manufacturing complexity can also be reduced.

Alternatively or also in addition to the aforementioned example variants, the second shift element and the third shift element are combined to form a shift element pair, with which one actuating element is associated. The second shift element, on the one hand, and the third shift element, on the other hand, can be actuated from a neutral position via this actuating element. As a result, the manufacturing complexity can be reduced, in that, due to the combination of the two shift elements to form a shift element pair, one actuating unit can be utilized for both shift elements.

According to one example embodiment of the invention, the rotor of the electric machine is rotationally fixed to the second input shaft. Alternatively, according to one example design option of the invention, the rotor is connected to the second input shaft via at least one gear stage. The electric machine can be arranged either coaxially to the planetary gear sets or so as to be situated axially offset with respect thereto. In the former case, the rotor of the electric machine can either be rotationally fixed directly to the second input shaft or can be coupled thereto via one or also multiple intermediate gear stage(s), wherein the latter allows for a more favorable configuration of the electric machine with higher rotational speeds and lower torques. The at least one gear stage can be designed as a spur gear stage and/or as a planetary gear stage in this case. In the case of a coaxial arrangement of the electric machine, the two planetary gear sets can then also, more preferably, be arranged axially in the area of the electric machine as well as radially internally with respect thereto, so that the axial installation length of the transmission can be shortened.

If the electric machine is provided axially offset with respect to the planetary gear sets, however, a coupling takes place via one or multiple intermediate gear stage(s) and/or a flexible traction drive mechanism. The one or the multiple gear stage(s) can also be implemented individually, in this case, either as a spur gear stage or as a planetary gear stage. A flexible traction drive mechanism can be either a belt drive or a chain drive.

Within the scope of example aspects of the invention, a starting component can be installed upstream from the transmission, for example a hydrodynamic torque converter or a friction clutch. This starting component can then also be an integral part of the transmission and acts to configure a starting process, in that the starting component enables a slip speed between the prime mover, which is designed, in particular, as an internal combustion engine, and the first input shaft of the transmission. In this case, one of the shift elements of the transmission or the separating clutch, which may be present, can also be designed as such a starting component, in that the starting component is present as a frictional shift element. In addition, a one-way clutch with respect to the transmission housing or to another shaft can be arranged on each shaft of the transmission, in principle.

The transmission is, in particular, part of a motor vehicle drive train for a hybrid or electric vehicle and is then arranged between a prime mover of the motor vehicle, which is configured as an internal combustion engine or as an electric machine, and further components of the drive train, which are arranged downstream in the direction of power flow to driving wheels of the motor vehicle. In this case, the first input shaft of the transmission is either permanently coupled to a crankshaft of the internal combustion engine or to the rotor shaft of the electric machine in a rotationally fixed manner or is connectable thereto via an intermediate separating clutch or a starting component, wherein a torsional vibration damper can also be provided between an internal combustion engine and the transmission. On the output end, the transmission is then preferably coupled, within the motor vehicle drive train, to a differential gear of a drive axle of the motor vehicle, wherein a connection to an interaxle differential can also be present in this case, however, via which a distribution to multiple driven axles of the motor vehicle takes place. The differential gear or the interaxle differential can be arranged with the transmission in one common housing in this case. A torsional vibration damper, which is optionally present, can also be integrated into this housing.

Within the meaning of the invention, the expressions that two components of the transmission are “connected” or “coupled” or “are connected to each other” mean a permanent coupling of these components, and therefore said components cannot rotate independently of each other. In that respect, no shift element is provided between these components, which can be elements of the planetary gear sets and/or also shafts and/or a rotationally fixed component of the transmission. Instead, the appropriate components are coupled to each other with a consistent rotational speed dependence.

However, if a shift element is provided between two components, these components are not permanently coupled to each other. Instead, a coupling is carried out only by actuating the intermediate shift element. In this case, an actuation of the shift element means, within the meaning of the invention, that the particular shift element is transferred into an engaged condition and, consequently, synchronizes the turning motions, if necessary, of the components connected directly thereto. In the case of an example embodiment of the particular shift element as a form-locking shift element, the components directly connected to each other in a rotationally fixed manner via the shift element rotate at the same rotational speed, while, in the case of a force-locking shift element, speed differences can exist between the components also after an actuation of the same shift element. This intentional or also unintentional condition is nevertheless referred to, within the scope of the invention, as a rotationally fixed connection of the particular components via the shift element.

The invention is not limited to the specified combination of features of the main claim or the claims dependent thereon. In addition, individual features can be combined with one another, provided they arise from the claims, the description of preferred embodiments of the invention which follows, or directly from the drawings. The reference in the claims to the drawings via the use of reference characters is not intended to limit the scope of protection of the claims.

### BRIEF DESCRIPTION OF THE DRAWING

Advantageous example embodiments of the invention, which are explained in the following, are represented in the drawings, in which:

FIG. 1 shows a diagrammatic view of a motor vehicle drive train;

FIG. 2 shows a diagrammatic view of a transmission of the type that can be utilized in the motor vehicle drive train from FIG. 1;

FIG. 3 shows a diagrammatic view of a transmission of the type that can be utilized in the motor vehicle drive train from FIG. 1;

FIG. 4 shows an exemplary gear shift matrix of the transmission from FIGS. 2 and 3;

FIG. 5 shows a diagrammatic view of a transmission of the type that can also be utilized in the motor vehicle drive train from FIG. 1;

FIG. 6 shows a diagrammatic view of a transmission of the type that can also be utilized in the motor vehicle drive train from FIG. 1;

FIG. 7 shows a diagrammatic view of a transmission of the type that can also be utilized in the motor vehicle drive train from FIG. 1; and

FIG. 8 shows an exemplary gear shift matrix of the transmission from FIGS. 5 through 7.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

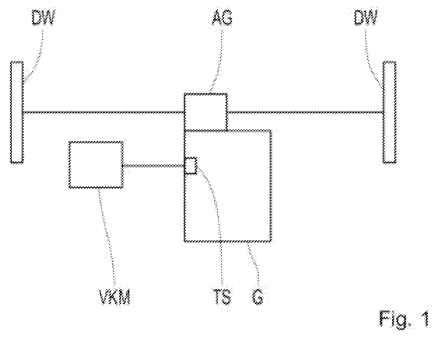

FIG. 1 shows a diagrammatic view of a motor vehicle drive train of a hybrid vehicle, wherein, in the motor vehicle drive train, an internal combustion engine VKM is connected to a transmission G via an intermediate torsional vibration damper TS. Connected downstream from the transmission G, on the output end thereof, is a differential gear AG, via which drive power is distributed to driving wheels DW of a drive axle of the motor vehicle. The transmission G and the torsional vibration damper TS are arranged in a common housing of the transmission G in this case, into which the differential gear can then also be integrated. The internal combustion engine VKM, the torsional vibration damper TS, the transmission G, and also the differential gear are aligned transversely to a direction of travel of the motor vehicle.

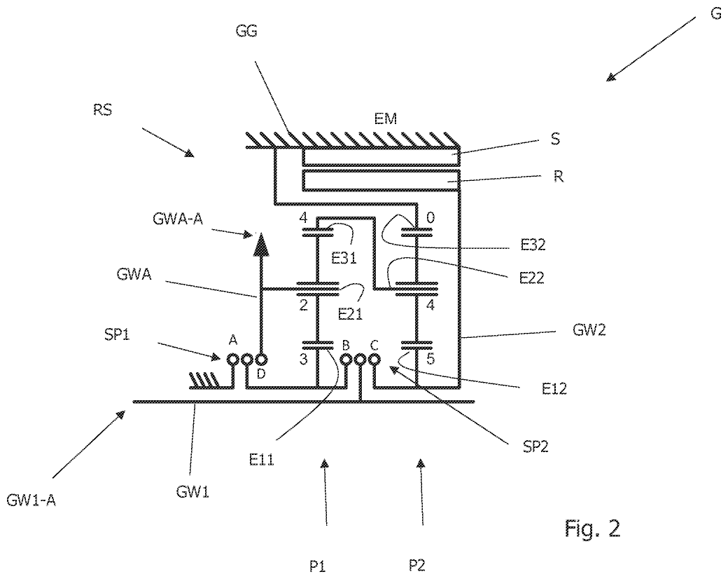

FIG. 2 shows a schematic of the transmission G according to a first example embodiment of the invention. As is apparent, the transmission G includes a gear set RS and an electric machine EM, which are both arranged in the housing of the transmission G. The gear set RS includes two planetary gear sets P1 and P2, wherein each of the planetary gear sets P1 and P2 includes a first element E11 and E12, respectively, a second element E21 and E22, respectively, and a third element E31 and E32, respectively. The first element E11 and E12 is formed by a sun gear of the planetary gear set P1 and P2, respectively, while the second element E21 and E22 of the planetary gear set P1 and P2, respectively, is present as a planet carrier, and the third element E31 and E32 of the planetary gear set P1 and P2, respectively, is present as a ring gear.

In the present case, the first planetary gear set P1 and the second planetary gear set P2 are each therefore present as a negative or minus planetary gear set. The particular planet carrier thereof guides at least one planet gear in a rotatably mounted manner; the planet gear is meshed with the particular radially internal sun gear as well as with the particular radially surrounding ring gear. It is particularly preferred, however, when multiple planet gears are provided in the case of the first and the second planetary gear set P1 and P2.

As is apparent in FIG. 2, the transmission G includes a first input shaft GW1, a second input shaft GW2, and an output shaft GWA, wherein the second input shaft GW2 is rotationally fixed to a rotor R of an electric machine EM. The transmission G also includes four shift elements in the form of a first shift element A, a second shift element B, a third shift element C, and a fourth shift element D. The shift elements A, B, C, and D are designed as form-locking shift elements and are preferably present as constant-mesh shift elements. The four shift elements A, B, C, and D are present as clutches.

The first element E11 of the first planetary gear set P1 is fixable by the first shift element A at a rotationally fixed component GG, which is the transmission housing of the transmission G or a portion of this transmission housing.

The first element E11 of the first planetary gear set P1 is rotationally fixable to the first input shaft GW1 by the second shift element B.

The first element E11 of the first planetary gear set P1 is rotationally fixable to the second element E21 of the first planetary gear set P1 by the fourth shift element D. If the first element E11 and the second element E21 are connected to each other, the first planetary gear set P1 is interlocked.

The second element E21 of the first planetary gear set P1 is rotationally fixed to the output shaft GWA and, thereby, forms the output of the transmission G.

The output is, for example, coupled to an axle differential. In order to change the rotational speed of the output shaft 2, a two-stage gear stage can be provided, in particular, which couples the output shaft GWA to the axle differential. The third element E31 of the first planetary gear set P1 is rotationally fixed to the second element E22 of the second planetary gear set P2.

The first element E12 of the second planetary gear set P2 is rotationally fixed to the second input shaft GW2. The first element E12 of the second planetary gear set P2 can be rotationally fixed to the first input shaft GW1 by the third shift element C. If the third shift element C is actuated, the two input shafts GW1, GW2 are connected to each other. The third element E32 of the second planetary gear set P2 is rotationally fixed at the rotationally fixed component GG.

The second input shaft GW2 is permanently connected to the rotor R1 of the electric machine EM, the stator S1 of which is permanently fixed at the rotationally fixed component GG.

The first input shaft GW1 as well as the output shaft GWA form a mounting interface GW1-A and GWA-A, respectively, wherein the mounting interface GW1-A in the motor vehicle drive train from FIG. 1 is utilized for a connection at the internal combustion engine VKM, while the transmission G is connected at the mounting interface GWA-A to the downstream differential gear AG. The mounting interface GW1-A of the first input shaft GW1 is formed at an axial end of the transmission G, while the mounting interface GWA-A of the output shaft GWA is situated in the area of the same axial end and, here, is aligned transversely to the mounting interface GW1-A of the first input shaft GW1. In addition, the first input shaft GW1, the second input shaft GW2, and the output shaft GWA are arranged coaxially to one another.

The planetary gear sets P1 and P2 are also situated coaxially to the input shafts GW1 and GW2 and the output shaft GWA, wherein the planetary gear sets P1 and P2 are arranged in the sequence first planetary gear set P1 and second planetary gear set P2 axially subsequent to the mounting interface GW1-A of the first input shaft GW1. Likewise, the electric machine EM is also located coaxially to the planetary gear sets P1, P2 and, thereby, also to the input shafts GW1 and GW2 and to the output shaft GWA, wherein the two planetary gear sets P1, P2 are arranged at least partially radially within the rotor R.

As is also apparent from FIG. 2, the second shift element B and the third shift element C are arranged axially between the first planetary gear set P1 and the second planetary gear set P2. The first shift element A and the fourth shift element D are situated axially on a side of the first planetary gear set P1 facing away from the second planetary gear set P2.

The shift elements A and D as well as the shift elements B and C are situated axially directly next to one another and are combined to form a shift element pair SP1 and SP2, respectively.

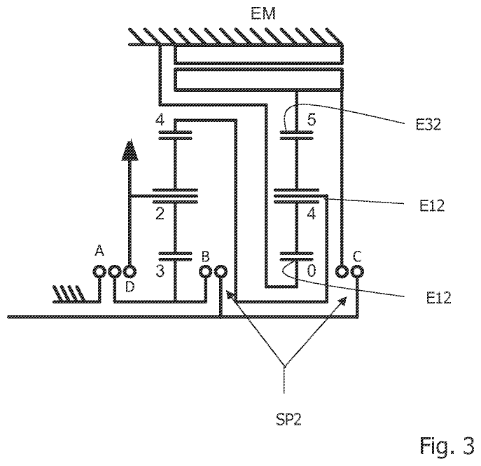

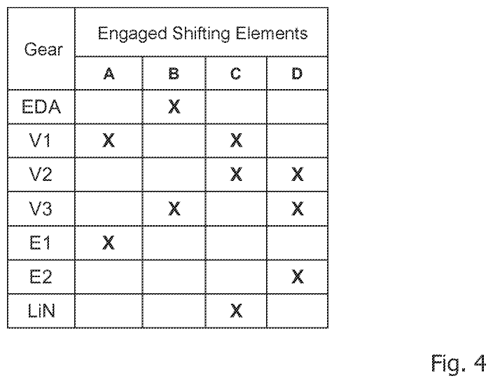

In FIG. 3, a variant of the example embodiment according to FIG. 2 is shown. In contrast to FIG. 2, the first element E12 of the second planetary gear set P2 is now fixed at the housing GG, whereas the third element E32 of the second planetary gear set P2 is rotationally fixed to the second input shaft. Due to the switch of the connections of the sun gear and the ring gear, the third shift element E32 is now arranged axially on a side of the second planetary gear set P2 facing away from the first planetary gear set P1. For the rest, the example variant according to FIG. 4 corresponds to the example design option according to FIG. 2, and therefore reference is made to the description thereof.

FIG. 4 shows an exemplary gear shift matrix for the transmissions G from FIGS. 2 and 3 in table form. As is apparent, a total of three gears 1 through 3, which differ with respect to the transmission ratio, can be implemented between the first input shaft GW1 and the output shaft GWA, wherein, in the columns of the gear shift matrix, an X indicates which of the shift elements A through D is actuated, i.e., engaged, in which of the gears 1 through 3.

As is apparent in FIG. 4, a first gear V1 can be implemented between the first input shaft GW1 and the output shaft GWA by actuating the first shift element A and the third shift element C. A second gear V2 can be implemented by actuating the shift elements C and D. A third gear V3 can be implemented by actuating the shift elements B and D.

The first gear can be selected purely electrically (E1) by actuating the first shift element A. The second gear can be selected purely electrically (E2) by actuating the fourth shift element D.

The gears V1 and V2 are hybrid. The gears E1, E2 are purely electric-motor gears. The gear V3 is a purely internal-combustion-engine gear. The ratio step between V1 and V2 corresponds to the ratio step between E1 and E2.

In addition, an electrodynamic starting operation (EDA) is possible when the second shift element B is actuated.

If only the third shift element C is actuated, charging in neutral (LiN) is possible. In this condition, the first input shaft GW1 and the second input shaft GW2 are connected to each other and are decoupled from the output.

A synchronization during the gear shifts can take place in each case via an appropriate closed-loop control of the upstream internal combustion engine VKM, and therefore the particular shift element to be disengaged is disengaged without load and the shift element to be subsequently engaged can be engaged without load.

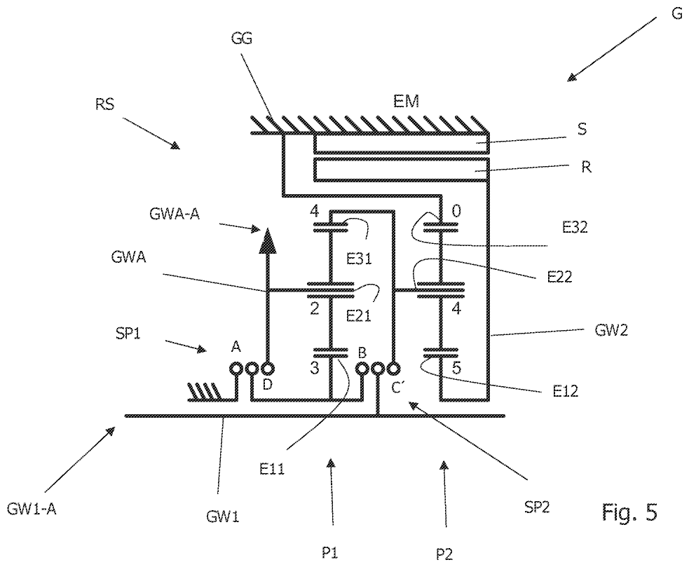

FIG. 5 shows a schematic of a transmission G according to a further example embodiment of the invention, of the type which can also be utilized in the motor vehicle drive train in FIG. 1.

As is apparent, the transmission G includes a gear set RS and an electric machine EM, which are both arranged in the housing of the transmission G. The gear set RS includes two planetary gear sets P1 and P2, wherein each of the planetary gear sets P1 and P2 includes a first element E11 and E12, respectively, a second element E21 and E22, respectively, and a third element E31 and E32, respectively. The first element E11 and E12 is formed by a sun gear of the planetary gear set P1 and P2, respectively, while the second element E21 and E22 of the planetary gear set P1 and P2, respectively, is present as a planet carrier, and the third element E31 and E32 of the planetary gear set P1 and P2, respectively, is present as a ring gear.

In the present case, the first planetary gear set P1 and the second planetary gear set P2 are each therefore present as a negative minus planetary gear set. The particular planet carrier thereof guides at least one planet gear in a rotatably mounted manner; the planet gear is meshed with the particular radially internal sun gear as well as with the particular radially surrounding ring gear. It is particularly preferred, however, when multiple planet gears are provided in the case of the first and the second planetary gear set P1 and P2.

As is apparent in FIG. 5, the transmission G includes a first input shaft GW1, a second input shaft GW2, and an output shaft GWA, wherein the second input shaft GW2 is rotationally fixed to a rotor R of an electric machine EM. The transmission G also includes four shift elements in the form of a first shift element A, a second shift element B, a third shift element C′, and a fourth shift element D. The shift elements A, B, C′, and D are designed as form-locking shift elements and are preferably present as constant-mesh shift elements. The four shift elements A, B, C′, and D are present as clutches.

The first element E11 of the first planetary gear set P1 is fixable by the first shift element A at a rotationally fixed component GG, which is the transmission housing of the transmission G or a portion of this transmission housing. The first element E11 of the first planetary gear set P1 is also rotationally fixable to the first input shaft GW1 by the second shift element B. The first element E11 of the first planetary gear set P1 is also rotationally fixable to the second element E21 of the first planetary gear set P1 by the fourth shift element D. If the first element E11 and the second element E21 are connected to each other, the first planetary gear set P1 is interlocked.

The second element E21 of the first planetary gear set P1 is rotationally fixed to the output shaft GWA and, thereby, forms the output of the transmission G. The output is, for example, coupled to an axle differential. In order to change the rotational speed of the output shaft 2, a two-stage gear stage can be provided, for example, which couples the output shaft 2 to the axle differential. The third element E31 of the first planetary gear set P1 is rotationally fixed to the second element E22 of the second planetary gear set P2.

The first element E12 of the second planetary gear set P2 is rotationally fixed to the second input shaft GW2. The second element E22 of the second planetary gear set P2 can be rotationally fixed to the first input shaft GW1 by the third shift element C′. The shift element C′ is preferably designed as a dog clutch. If the third shift element C′ is actuated, the two input shafts are not connected to each other directly, but rather via the second planetary gear set. The third element E32 of the second planetary gear set P2 is fixed at the rotationally fixed component GG. The second planetary gear set operates, in other words, as a type of fixed ratio of the electric machine.

The second input shaft GW2 is permanently connected to the rotor R1 of the electric machine EM, the stator S1 of which is permanently fixed at the rotationally fixed component GG.

The first input shaft GW1 as well as the output shaft GWA form a mounting interface GW1-A and GWA-A, respectively, wherein the mounting interface GW1-A in the motor vehicle drive train from FIG. 1 is utilized for a connection at the internal combustion engine VKM, while the transmission G is connected at the mounting interface GWA-A to the downstream differential gear AG. The mounting interface GW1-A of the first input shaft GW1 is formed at an axial end of the transmission G, while the mounting interface GWA-A of the output shaft GWA is situated in the area of the same axial end and, here, is aligned transversely to the mounting interface GW1-A of the first input shaft GW1. In addition, the first input shaft GW1, the second input shaft GW2, and the output shaft GWA are arranged coaxially to one another.

The planetary gear sets P1 and P2 are also situated coaxially to the input shafts GW1 and GW2 and the output shaft GWA, wherein they are arranged in the sequence first planetary gear set P1 and second planetary gear set P2 axially subsequent to the mounting interface GW1-A of the first input shaft GW1. Likewise, the electric machine EM is also located coaxially to the planetary gear sets P1, P2 and, thereby, also to the input shafts GW1 and GW2 and to the output shaft GWA, wherein the two planetary gear sets P1, P2 are arranged at least partially radially within the rotor R.

As is also apparent from FIG. 5, the second shift element B and the third shift element C are arranged axially between the first planetary gear set P1 and the second planetary gear set P2. The first shift element A and the fourth shift element D are situated axially on a side of the first planetary gear set P1 facing away from the second planetary gear set P2.

The shift elements A and D as well as the shift elements B and C′ are situated axially directly next to one another and are combined to form a shift element pair SP1 and SP2, respectively.

The difference from the example embodiment according to FIG. 2, therefore, lies in the alternative arrangement of the third shift element C and C′. In the LiN (charging in neutral) mode, this advantageously results in a higher rotational speed level of the rotor R connected to the second input shaft GW2.

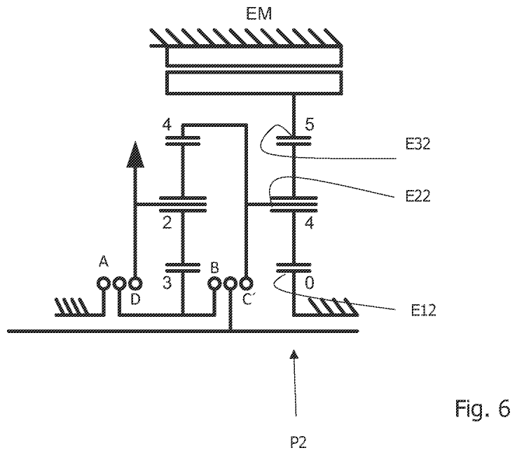

FIG. 6 shows a variant of the example embodiment according to FIG. 5. In contrast to FIG. 5, the first element E12 of the second planetary gear set P2 is now fixed at the housing GG, whereas the third element E32 of the second planetary gear set P2 is rotationally fixed to the second input shaft GW2. In other words, the example embodiments from FIGS. 5 and 6 differ only with respect to the pre-ratio of the electric machine EM by the second planetary gear set P2. The example embodiment according to FIG. 5 has a higher pre-ratio than the example embodiment according to FIG. 6. For the rest, the example variant according to FIG. 6 corresponds to the example design option according to FIG. 5, and therefore reference is made to the description thereof.

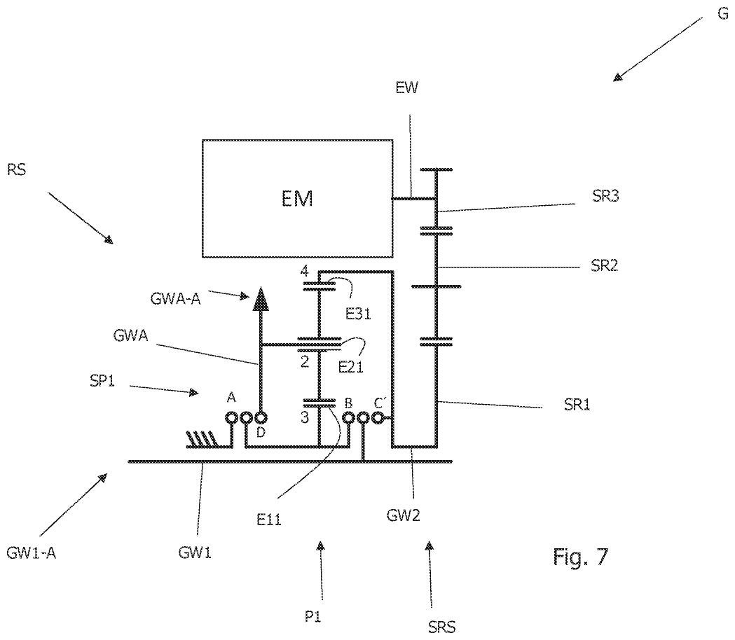

FIG. 7 shows a schematic of a transmission G according to a further example embodiment of the invention, of the type which can also be utilized in the motor vehicle drive train in FIG. 1.

As is apparent, the transmission G includes a gear set RS, a pre-ratio SRS configured as a spur gear transmission, and an electric machine EM, which are all arranged in the housing of the transmission G. The gear set RS includes a planetary gear set P1, wherein the planetary gear set P1 includes a first element E11, a second element E21, and a third element E31. The first element E11 is formed by a sun gear, while the second element E21 is present as a planet carrier and the third element E31 is present as a ring gear.

In the present case, the first planetary gear set P1 is therefore present as a negative or minus planetary gear set, the planet carrier of which guides at least one planet gear in a rotatably mounted manner. The at least one planet gear is meshed with the particular radially internal sun gear as well as with the particular radially surrounding ring gear. It is particularly preferred when multiple planet gears are present in the planetary gear set P1.

The transmission G includes a first input shaft GW1, a second input shaft GW2, and an output shaft GWA. The transmission G also includes four shift elements in the form of a first shift element A, a second shift element B, a third shift element C′, and a fourth shift element D. The shift elements A, B, C′, and D are designed as form-locking shift elements and are preferably present as constant-mesh shift elements. The four shift elements A, B, C′, and D are present as clutches.

The electric machine EM shown in FIG. 7 is not located coaxially to the particular gear set RS of the transmission G, but rather axially offset with respect thereto. A connection takes place via a spur gear stage SRS, which includes a first spur gear SR1, a second spur gear SR2, and a third spur gear SR3. The first spur gear SR1 is connected at the second input shaft GW2 in a rotationally fixed manner on the side of the particular gear set RS. The spur gear SR1 is then meshed with the rotatably mounted spur gear SR2. The second gear SR2 is meshed with the third spur gear SR3, which is located on an input shaft EW of the electric machine EM in a rotationally fixed manner, which establishes, within the electric machine EM, the connection to the rotor (not represented further in this case) of the electric machine EM.

The first element E11 of the first planetary gear set P1 is fixable by the first shift element A at a rotationally fixed component GG, which is the transmission housing of the transmission G or a portion of this transmission housing CG. The first element E11 of the first planetary gear set P1 is also rotationally fixable to the first input shaft GW1 by the second shift element B. The first element E11 of the first planetary gear set P1 is also rotationally fixable to the second element E21 of the first planetary gear set P1 by the fourth shift element D. If the first element E11 and the second element E21 are connected to each other, the first planetary gear set P1 is interlocked.

The second element E21 of the first planetary gear set P1 is rotationally fixed to the output shaft GWA and, thereby, forms the output of the transmission G. The output is, for example, coupled to an axle differential. In order to change the rotational speed of the output shaft 2, a two-stage gear stage can be provided, for example, which couples the output shaft 2 to the axle differential.

The third element E31 of the first planetary gear set P1 is, as mentioned above, rotationally fixed to the first spur gear SR1. Both elements E31, SR1 can be rotationally fixed to the first input shaft GW1 by the third shift element C′. If the third shift element C′ is actuated, the two input shafts GW1, GW2 are directly connected to each other.

The first input shaft GW1 as well as the output shaft GWA form a mounting interface GW1-A and GWA-A, respectively, wherein the mounting interface GW1-A in the motor vehicle drive train from FIG. 1 is utilized for a connection at the internal combustion engine VKM, while the transmission G is connected at the mounting interface GWA-A to the downstream differential gear. The mounting interface GW1-A of the first input shaft GW1 is formed at an axial end of the transmission G, while the mounting interface GWA-A of the output shaft GWA is situated in the area of the same axial end and, here, is aligned transversely to the mounting interface GW1-A of the first input shaft GW1. In addition, the first input shaft GW1 and the output shaft GWA are arranged coaxially to each other.

The planetary gear set P1 and the pre-ratio in the spur gear design SRS are situated coaxially to the input shaft GW1, GW2 and the output shaft GWA. The electric machine EM can be connected to the first planetary gear set P1, rather than via one or multiple spur gear(s), also via a chain or a belt.

As is also apparent from FIG. 7, the second shift element B and the third shift element C are arranged axially between the first planetary gear set P1 and the spur gear stage SRS. The first shift element A and the fourth shift element D are situated axially on a side of the first planetary gear set P1 facing away from the spur gear stage SRS. The shift elements A and D as well as the shift elements B and C′ are situated axially directly next to one another and are combined to form a shift element pair SP1 and SP2, respectively.

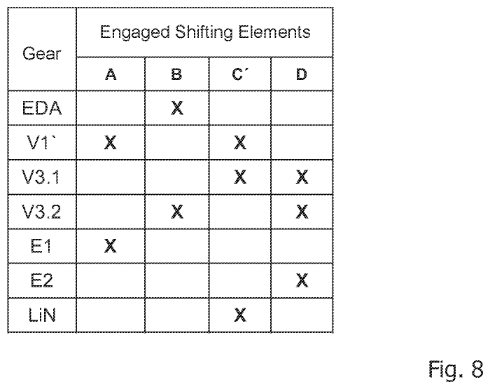

FIG. 8 shows an exemplary gear shift matrix for the transmissions G from FIGS. 5 and 6 in table form. As is apparent, a total of three gears 1 through 3, which differ with respect to the transmission ratio, can be implemented between the first input shaft GW1 and the output shaft GWA, wherein, in the columns of the gear shift matrix, an X indicates which of the shift elements A through D is actuated, i.e., engaged, in which of the gears 1 through 3.

As is apparent in FIG. 8, a first gear V1′ can be implemented between the first input shaft GW1 and the output shaft GWA by actuating the first shift element A and the third shift element C′. A third gear can be implemented in a first example variant V3.1 by actuating the shift elements C′ and D. A third gear can be implemented in a second example variant V3.2 by actuating the shift elements B and D.

Gear 3 is now implementable using two different shift logics, i.e., in two example variants.

The first gear can be selected purely electrically (E1) by actuating the first shift element A. The second gear can be selected purely electrically (E2) by actuating the fourth shift element D.

The gears V1′ and V3.1 are hybrid. The gears E1, E2 are purely electric-motor gears. The gear V3.2 is a purely internal-combustion-engine gear.

The first gear V1′ has a lower ratio than the first gear V1 of the example embodiments from FIGS. 2 and 3. The ratio step between V1′ and V3.1 and/or V3.2 corresponds to the ratio step between E1 and E2.

In addition, an electrodynamic starting operation (EDA) is possible when the second shift element B is actuated.

If only the third shift element C′ is actuated, charging in neutral (LiN) is possible, wherein, in contrast to the clutch assembly in FIGS. 2 and 3, the rotor has a higher rotational speed level.

A synchronization during the gear shifts can take place in each case via an appropriate closed-loop control of the upstream internal combustion engine VKM, and therefore the particular shift element to be disengaged is disengaged without load and the shift element to be subsequently engaged can be engaged without load.

By the example embodiments according to the invention, a transmission having a compact design and good efficiency can be implemented. The transmission can be actuated using only two actuators. Two purely electric gears signify a rather low torque demand, and so the electric machine can be small-dimensioned.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

G transmission
RS gear set
GG rotationally fixed component
P1 first planetary gear set
E11 first element of the first planetary gear set
E21 second element of the first planetary gear set
E31 third element of the first planetary gear set
P2 second planetary gear set
E12 first element of the second planetary gear set
E22 second element of the second planetary gear set
E32 third element of the second planetary gear set
A first shift element
B second shift element
C, C′ third shift element
D fourth shift element
SP1 shift element pair
SP2 shift element pair
V1 first gear
V2 second gear
V3 third gear
V3.1 third gear, first variant
V3.2 third gear, second variant
E1 first gear, electric
E2 second gear, electric
GW1 first input shaft
GW1-A mounting interface
GW2 second input shaft
GWA output shaft
GWA-A mounting interface
AN connection shaft
EM electric machine
S stator
R rotor
SRS spur gear stage
SR1 spur gear
SR2 spur gear
SR3 spur gear
HO ring gear
VKM internal combustion engine
DW driving wheels

1-11: (canceled)

12. A transmission (G) for a motor vehicle, comprising
an electric machine (EM);
a first input shaft (GW1);
a second input shaft (GW2);
an output shaft (GWA);
a planetary gear set (P1) with a first elements (E11), a second element (E21), and a third element (E31);
a plurality of shift elements with a first shift element (A), a second shift element (B), a third shift element (C′), and a fourth shift element (D); and
a pre-ratio configured as a spur gear transmission (SRS) with a plurality of spur gears (SR1, SR2, SR3),
wherein the first element (E11) of the planetary gear set (P1) is fixable at a rotationally fixed component (GG) by the first shift element (A),
wherein the first input shaft (GW1) is rotationally fixable to the first element of the first planetary gear set (P1) by the second shift element (B),
wherein the first planetary gear set (P1) is interlockable by connecting two of first, second, and third elements (E11, E21, E31) in a rotationally fixed manner by the fourth shift element (D),
wherein the second element (E21) of the first planetary gear set (P1) is rotationally fixed to the output shaft (GWA),
wherein a rotor of the electric machine is connected to the second input shaft (GW2) via the pre-ratio configured as the spur gear transmission (SRS),
wherein the second input shaft (GW2) is rotationally fixed to the third element (E31) of the planetary gear set (P1), and
wherein the third shift element (C′) is configured for rotationally fixing the first input shaft (GW1) to the second input shaft (GW2).

13. The transmission (G) of claim 12, wherein selective engagement of the plurality of shift elements (A, B, C′, D) results in:
a first gear (V1) between the first input shaft (GW1) and the output shaft (GWA) by actuating the first shift element (A) and the third shift element (C′); and
a third gear (V3) between the first input shaft (GW1) and the output shaft (GWA) by actuating the third shift element (C′) and the fourth shift element (D).

14. The transmission (G) of claim 12, wherein selective engagement of the plurality of shift elements (A, B, C′, D) results in:
a first gear (V1) between the first input shaft (GW1) and the output shaft (GWA) by actuating the first shift element (A) and the third shift element (C′); and
a third gear (V3) between the first input shaft (GW1) and the output shaft (GWA) by actuating the second shift element (B) and the fourth shift element (D).

15. The transmission (G) of claim 12, wherein:
a first gear (E1) results between the second input shaft (GW2) and the output shaft (GWA) by actuating the first shift element (A); and
a second gear (E2) results between the second input shaft (GW2) and the output shaft (GWA) by actuating the fourth shift element (D).

16. The transmission (G) of claim 12, wherein an electrodynamic starting operation (EDA) is implementable by actuating the second shift element (B).

17. The transmission (G) of claim 12, wherein one or more of the plurality of shift elements (A, B, C′, D) is a form-locking shift element.

18. The transmission (G) of claim 12, wherein the planetary gear set (P1) is a minus planetary gear set, the first element (E11) is a sun gear, the second element (E21) is a planet carrier, and the third element (E31) is a ring gear.

19. The transmission (G) of claim 12, wherein the first shift element (A) and the fourth shift element (D) are combined as a first shift element pair (SP1) with an associated actuating element via which the first shift element (A) and the fourth shift element (D) are respectively actuatable from a neutral position.

20. The transmission (G) of claim 12, wherein the third shift element (C′) and the second shift element (B) are combined to form a second shift element pair (SP2) with an associated actuating element via which the third shift element (C′) and the second shift element (B) are respectively actuatable from a neutral position.

21. The transmission (G) of claim 12, wherein the rotor (R) of the electric machine (EM) is rotationally fixed to the second input shaft (GW2) or is connected to the second input shaft (GW2) via at least one gear stage.

22. A motor vehicle drive train for a hybrid or electric vehicle, comprising the transmission (G) of claim 12.

23. A method for operating the transmission (G) of claim 12, wherein only the third shift element (C) is engaged in order to implement a charging operation or a starting operation.
